(19) United States
(12) Patent Application Publication
(10) Pub. No.: US 2012/0134395 A1
(43) Pub. Date: May 31, 2012

(54) Power Line Communications (PLC) Across Different Voltage Domains Using Multiple Frequency Subbands

(75) Inventors: Badri N. Varadarajan, Mountain View, CA (US); Anand G. Dabak, Plano, TX (US); Il Han Kim, Dallas, TX (US); Xiaolin Lu, Plano, TX (US)

(73) Assignee: TEXAS INSTRUMENTS INCORPORATED, Dallas, TX (US)

(21) Appl. No.: 13/300,741

(22) Filed: Nov. 21, 2011

Related U.S. Application Data
(60) Provisional application No. 61/418,073, filed on Nov. 30, 2010.
(60) Provisional application No. 61/423,664, filed on Dec. 16, 2010.

(51) Int. Cl. H04B 3/54; H04B 17/00; H04B 1/38

(52) U.S. Cl. 375/220; 375/257; 375/227

(57) ABSTRACT

Systems and methods for implementing power line communications (PLC) across different voltage domains using multiple frequency subbands are described. From an end node's perspective (e.g., a PLC device), a method may include scanning a plurality of downlink subbands usable by a base node (e.g., a PLC router, etc.) to communicate with one or more PLC devices (e.g., other end nodes) from a medium voltage (MV) to a low voltage (LV) power line, and transmitting association request(s) to the base node that select and/or allow the base node to select one or more downlink subbands for use in subsequent communications. From the base node's perspective, the method may include selecting one or more of a plurality of uplink subbands for use in subsequent communications based on the received association request(s). In various implementations, the selection of downlink and/or uplink subbands may be based on signal-to-noise ratio (SNR) values and/or congestion indicators.

### CROSS-REFERENCE TO RELATED APPLICATIONS

This application claims the benefit of the filing date of U.S. Provisional Patent Application No. 61/418,073, which is titled “Subband Flex OFDM for MV LV Communications” and was filed on Nov. 30, 2010, and of U.S. Provisional Patent Application No. 61/423,664, which is titled “Operation Over Multiple PHY Subbands for MV-LV Communication” and was filed on Dec. 16, 2010, the disclosures of which are hereby incorporated by reference herein in their entirety.

### TECHNICAL FIELD

Embodiments are directed, in general, to power line communications (PLC), and, more specifically, to power line communications (PLC) across different voltage domains using multiple frequency subbands.

### BACKGROUND

Power line communications (PLC) include systems for communicating data over the same medium (i.e., a wire or conductor) that is also used to transmit electric power to residences, buildings, and other premises. Once deployed, PLC systems may enable a wide array of applications, including, for example, automatic meter reading and load control (i.e., utility-type applications), automotive uses (e.g., charging electric cars), home automation (e.g., controlling appliances, lights, etc.), and/or computer networking (e.g., Internet access), to name only a few.

Various PLC standardizing efforts are currently being undertaken around the world, each with its own unique characteristics. Generally speaking, PLC systems may be implemented differently depending upon local regulations, characteristics of local power grids, etc. Examples of competing PLC standards include the IEEE 1901, HomePlug AV, Powerline Intelligent Metering Evolution (PRIME), and the ITU-T G.hn (e.g., G.9960 and G.9961) specifications.

### SUMMARY

Systems and methods for implementing power line communications (PLC) across different voltage domains using multiple frequency subbands are described. In an illustrative embodiment, a method may include scanning a plurality of downlink subbands usable by a base node to communicate with one or more PLC devices from a medium voltage (MV) power line to a low voltage (LV) power line and transmitting an association request to the base node. The method may also include, in response to the request, receiving a message from the base node addressed to the PLC device, the message having been transmitted from the base node to the PLC device using one or more selected ones of the plurality of downlink subbands.

In some implementations, scanning the plurality of downlink subbands may include scanning each of the plurality of downlink subbands over multiple time slots. Additionally or alternatively, scanning the plurality of downlink subbands may include scanning two or more of the plurality of downlink subbands in parallel.

The method may further include determining a signal-to-noise ratio (SNR) value for each of the plurality of downlink subbands. In some cases, determining the SNR for a given one of the plurality of downlink subbands may include receiving a beacon packet from the base node, the beacon packet having been transmitted using the given one of the plurality of downlink subbands. The association request may include the SNR value for each of the plurality of downlink subbands, and it may be configured to allow the base node to choose the one or more selected ones of the plurality of downlink subbands. Additionally or alternatively, the association request may include an indication of the one or more selected ones of the plurality of downlink subbands, and the one or more selected ones of the plurality of downlink subbands may have the smallest SNR values compared to other downlink subbands.

In some cases, transmitting the association request further may include transmitting the association request to the base node over two or more of a plurality of uplink subbands, the association request may be configured to allow the base node to choose one or more selected ones of the plurality of uplink subbands, and the received message may indicate the one or more selected ones of the plurality of uplink subbands. As such, the method may include maintaining subsequent communications with the base node using the one or more selected ones of the plurality of downlink subbands and the one or more selected ones of the plurality of uplink subbands.

The method may also include re-scanning the plurality of downlink subbands, determining an updated signal-to-noise ratio (SNR) value for each of the plurality of downlink subbands, and transmitting a message to the base node. The message may include an indication of another selected one of the plurality of downlink subbands to be used in a subsequent communication and/or the updated SNR values for each of the plurality of downlink subbands, and it may be configured to allow the base node to choose another selected one of the plurality of downlink subbands to be used in a subsequent communication.

In another illustrative embodiment, a method may include receiving a plurality of association requests from an end node, each of the plurality of association requests having been transmitted via one of a plurality of uplink subbands from a low voltage (LV) power line to a medium voltage (MV) power line. The method may also include identifying, based at least in part upon the plurality of association requests, one or more selected ones of a plurality of downlink subbands and choosing, based at least in part upon the plurality of association requests, one or more selected ones of the plurality of uplink subbands. The method may further include communicating with the end node using the one or more selected ones of the plurality of downlink subbands and the one or more selected ones of the plurality of uplink subbands.

Each of the plurality of association requests may include a signal-to-noise ratio (SNR) value for each of the plurality of downlink subbands such that, to identify the one or more selected ones of the plurality of downlink subbands, the method may select one or more downlink subbands with smallest SNR values among other downlink subbands. Furthermore, to choose the one or more selected ones of the plurality of uplink subbands, the method may include determining a signal-to-noise ratio (SNR) value for each of the plurality of uplink subbands based, at least in part, upon the plurality of association requests and selecting the one or more uplink subbands with smallest SNR values among other uplink subbands.

In yet another illustrative embodiment, a method may include identifying a signal-to-noise ratio (SNR) value for each of a plurality of downlink subbands available for communications from a medium voltage (MV) power line to a low voltage (LV) power line and selecting one or more of the plurality of downlink subbands to be used in subsequent communications from the MV power line to the LV power line based, at least, in part, upon the SNR values. The method may also include identifying a congestion indicator corresponding to each of the plurality of downlink subbands, and selecting the one or more of the plurality of downlink subbands based, at least in part, upon the SNR values and the congestion indicators.

In some cases, the method may include identifying an SNR value for each of a plurality of uplink subbands available for communications from the LV power line to the MV power line, and selecting one or more of the plurality of uplink subbands to be used in subsequent communications from the LV power line to the MV power line based, at least, in part, upon the SNR values. The method may also include identifying a congestion indicator corresponding to each of the plurality of uplink subbands and selecting the one or more of the plurality of uplink subbands based, at least in part, upon the SNR values and the congestion indicators.

In some embodiments, a PLC device (e.g., a PLC modem, a PLC router, etc.) may perform one or more of the techniques described herein. In other embodiments, a tangible electronic storage medium may have program instructions stored thereon that, upon execution by a processor within one or more PLC devices, cause the one or more PLC devices to perform one or more operations disclosed herein. Examples of such a processor include, but are not limited to, a digital signal processor (DSP), an application specific integrated circuit (ASIC), a system-on-chip (SoC) circuit, a field-programmable gate array (FPGA), a microprocessor, or a microcontroller. In yet other embodiments, a PLC device may include at least one processor and a memory coupled to the at least one processor, the memory configured to store program instructions executable by the at least one processor to cause the PLC device to perform one or more operations disclosed herein.

### BRIEF DESCRIPTION OF THE DRAWINGS

Having thus described the invention(s) in general terms, reference will now be made to the accompanying drawings, wherein:

FIG. 1A is a diagram of a PLC environment according to some embodiments.

FIG. 1B is another diagram of the PLC environment according to some embodiments.

FIG. 2 is a block diagram of a PLC device or modem according to some embodiments.

FIG. 3 is a block diagram of a PLC gateway according to some embodiments.

FIG. 4 is a block diagram of a PLC data concentrator or router according to some embodiments.

FIG. 5 is a diagram of an example of a steady-state network map according to some embodiments.

FIG. 6 is a graph of a time slot definition according to some embodiments.

FIG. 7 is a graph providing an overview of slot usage according to some embodiments.

FIG. 8 is a diagram of a network discovery procedure according to some embodiments.

FIG. 9 is a diagram of an example of steady-state MV to LV slot usage according to some embodiments.

FIG. 10 is a diagram of an example of steady state LV to MV slot usage according to some embodiments.

FIG. 11 is a flowchart of a method for PLC communications across different voltage domains using multiple frequency subbands from the perspective of an end node or device according to some embodiments.

FIG. 12 is a flowchart of a method for PLC communications across different voltage domains using multiple frequency subbands from the perspective of a base node or device according to some embodiments.

FIG. 13 is a flowchart of another method for PLC communications across different voltage domains using multiple frequency subbands according to some embodiments.

FIG. 14 is a block diagram of an integrated circuit according to some embodiments.

### DETAILED DESCRIPTION

The invention(s) now will be described more fully hereinafter with reference to the accompanying drawings. The invention(s) may, however, be embodied in many different forms and should not be construed as limited to the embodiments set forth herein. Rather, these embodiments are provided so that this disclosure will be thorough and complete, and will fully convey the scope of the invention(s) to a person of ordinary skill in the art. A person of ordinary skill in the art may be able to use the various embodiments of the invention(s).

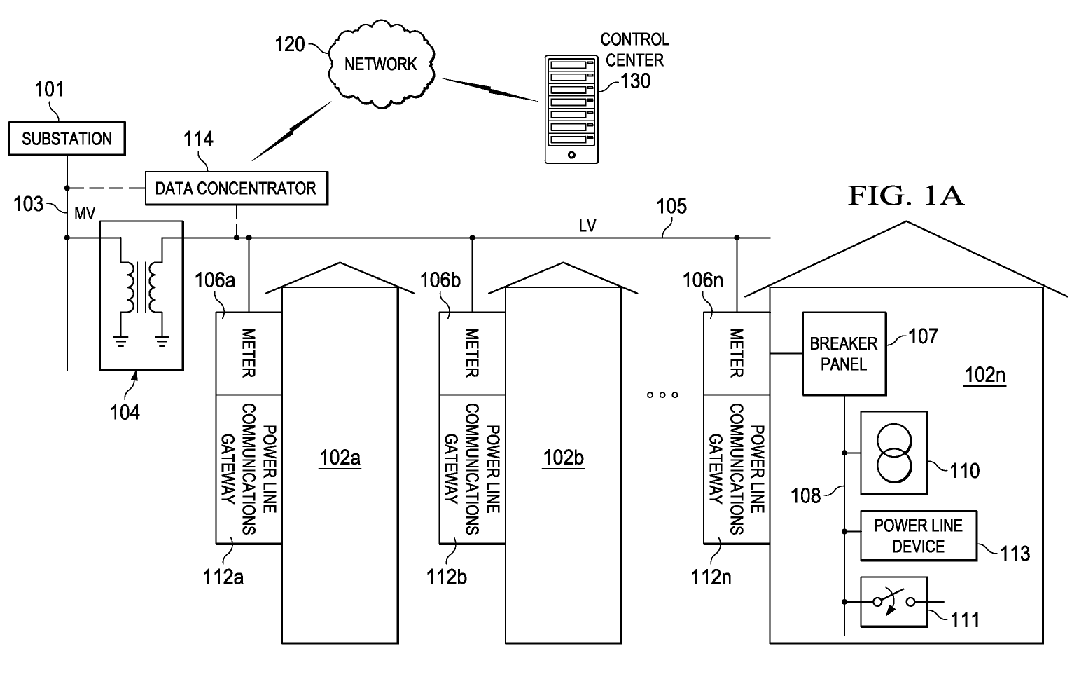

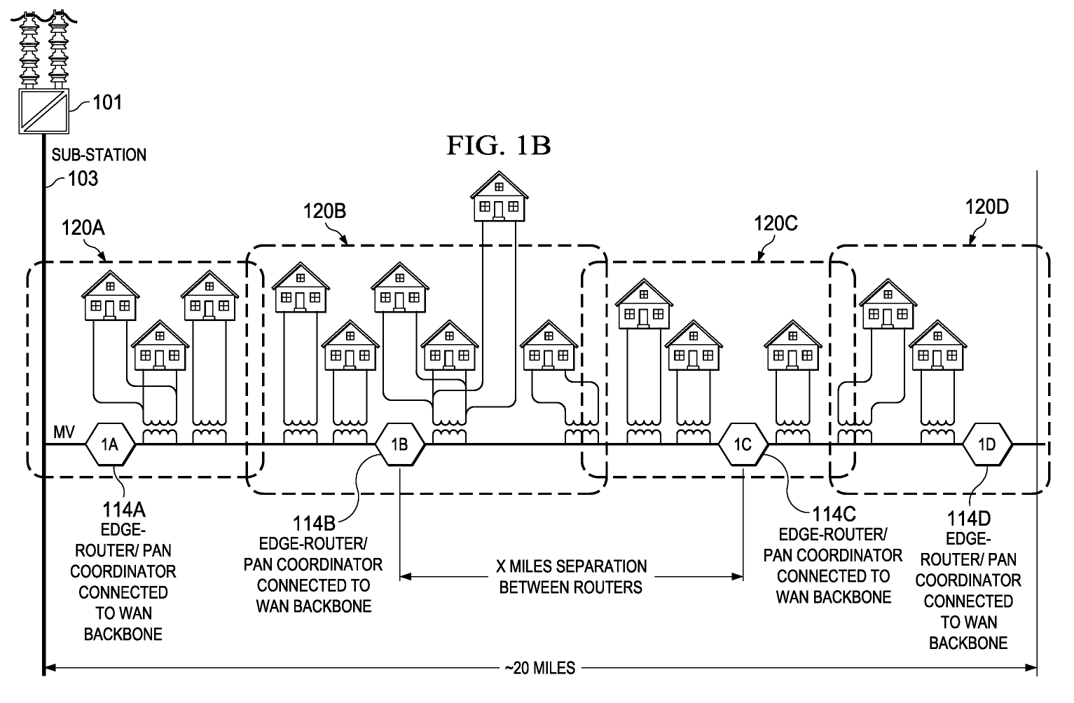

Turning to FIG. 1A, a power line communication (PLC) system is depicted according to some embodiments. Medium voltage (MV) power lines 103 from substation 101 typically carry voltage in the tens of kilovolts range. Transformer 104 steps the MV power down to low voltage (LV) power on LV lines 105, carrying voltage in the range of 100-240 VAC. Transformer 104 is typically designed to operate at very low frequencies in the range of 50-60 Hz. Transformer 104 does not typically allow high frequencies, such as signals greater than 100 KHz, to pass between LV lines 105 and MV lines 103. LV lines 105 feed power to customers via meters 106a-n, which are typically mounted on the outside of residences 102a-n. (Although referred to as “residences,” premises 102a-n may include any type of building, facility or location where electric power is received and/or consumed.) A breaker panel, such as panel 107, provides an interface between meter 106n and electrical wires 108 within residence 102n. Electrical wires 108 deliver power to outlets 110, switches 111 and other electric devices within residence 102n.

The power line topology illustrated in FIG. 1A may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use, for example, a carrier signal having a frequency different from that of the power signal. The carrier signal may be modulated by the data, for example, using an orthogonal frequency division multiplexing (OFDM) scheme or the like.

PLC modems or gateways 112a-n at residences 102a-n use the MV/LV power grid to carry data signals to and from PLC data concentrator or router 114 without requiring additional wiring. Concentrator or router 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, power line communication networks may provide street lighting control and remote power meter data collection.

One or more concentrators or routers 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

FIG. 1B is another diagram of the PLC system according to some embodiments. As illustrated, a plurality of PLC data concentrators or routers 114A-D are installed on an MV power line (e.g., 103) connected to a substation (e.g., 101). Each PLC router 114A-D is in turn coupled to a number of PLC devices (e.g., 113, 112a-n, etc.) in areas 120A-D, each PLD device coupled to an LV power line (e.g., 105), and each LV power line may be coupled to the MV power line via a transformer (e.g., 104). Generally speaking, the inter-spacing “x” between PLC routers 114A-D dictates the cost of the PLC network deployment. Under the current G3-FCC standard, x is approximately between 0.6 and 0.8 miles. This means that, along a 20-mile long MV power line, approximately 25 to 35 PLC routers are typically deployed. In some cases, using some of the techniques described herein, x may be increased to approximately 3 to 4 miles, and therefore only 5 to 7 PLC routers 114A-D may be needed to cover the same 20-mile MV line.

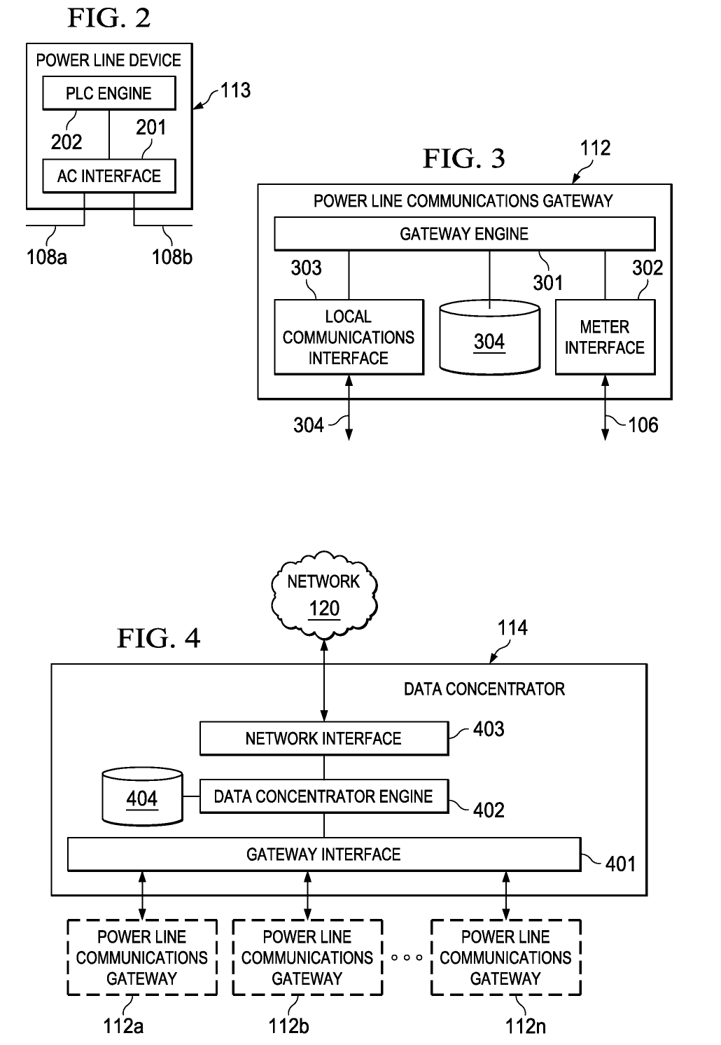

FIG. 2 is a block diagram of PLC device 113 according to some embodiments. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. In some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data aggregators 114, etc.) for further processing. Conversely, PLC engine 202 may receive instructions and/or other information from such higher-level PLC devices encoded in PLC signals, for example, to allow PLC engine 202 to select a particular frequency band in which to operate.

FIG. 3 is a block diagram of PLC gateway 112 according to some embodiments. As illustrated in this example, gateway engine 301 is coupled to meter interface 302, local communication interface 304, and frequency band usage database 304. Meter interface 302 is coupled to meter 106, and local communication interface 304 is coupled to one or more of a variety of PLC devices such as, for example, PLC device 113. Local communication interface 304 may provide a variety of communication protocols such as, for example, ZIGBEE, BLUETOOTH, WI-FI, WI-MAX, ETHERNET, etc., which may enable gateway 112 to communicate with a wide variety of different devices and appliances. In operation, gateway engine 301 may be configured to collect communications from PLC device 113 and/or other devices, as well as meter 106, and serve as an interface between these various devices and PLC data concentrator or router 114. Gateway engine 301 may also be configured to allocate frequency bands to specific devices and/or to provide information to such devices that enable them to self-assign their own operating frequencies.

In some embodiments, PLC gateway 112 may be disposed within or near premises 102n and serve as a gateway to all PLC communications to and/or from premises 102n. In other embodiments, however, PLC gateway 112 may be absent and PLC devices 113 (as well as meter 106n and/or other appliances) may communicate directly with PLC data concentrator or router 114. When PLC gateway 112 is present, it may include database 304 with records of frequency bands currently used, for example, by various PLC devices 113 within premises 102n. An example of such a record may include, for instance, device identification information (e.g., serial number, device ID, etc.), application profile, device class, and/or currently allocated frequency band. As such, gateway engine 301 may use database 304 in assigning, allocating, or otherwise managing frequency bands assigned to its various PLC devices.

FIG. 4 is a block diagram of a PLC data concentrator or router according to some embodiments. Gateway interface 401 is coupled to data concentrator engine 402 and may be configured to communicate with one or more PLC gateways 112a-n. Network interface 403 is also coupled to data concentrator engine 402 and may be configured to communicate with network 120. In operation, data concentrator engine 402 may be used to collect information and data from multiple gateways 112a-n before forwarding the data to control center 130. In cases where PLC gateways 112a-n are absent, gateway interface 401 may be replaced with a meter and/or device interface (now shown) configured to communicate directly with meters 116a-n, PLC devices 113, and/or other appliances. Further, if PLC gateways 112a-n are absent, frequency usage database 404 may be configured to store records similar to those described above with respect to database 304.

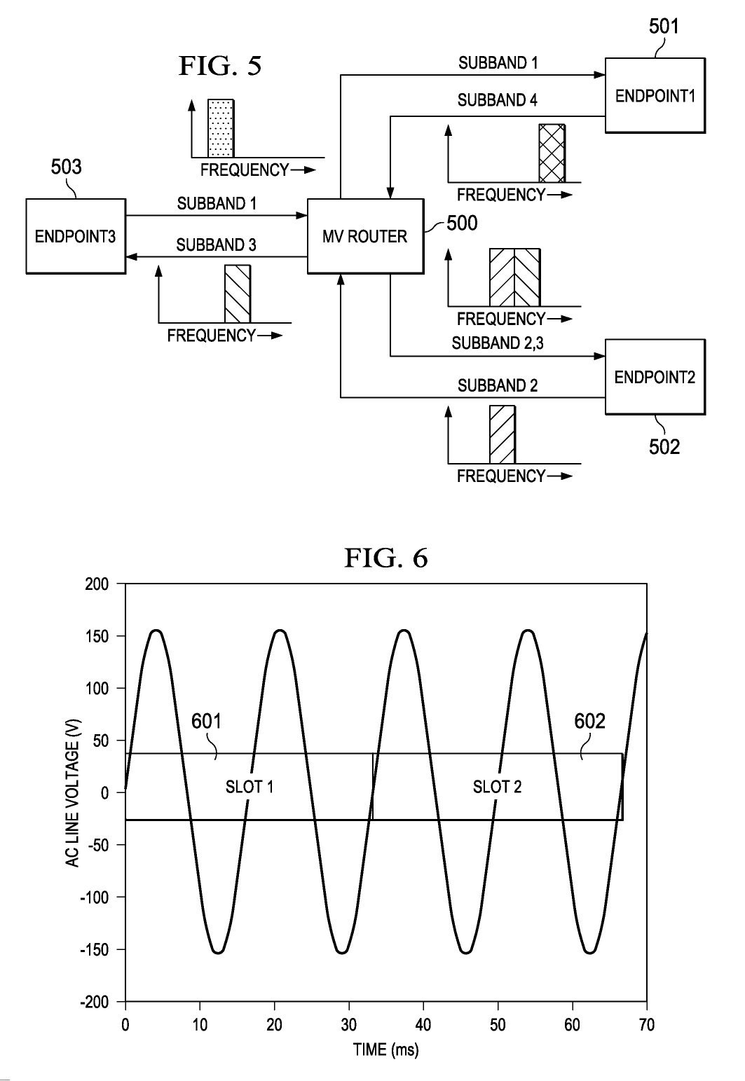

FIG. 5 is a diagram of an example of steady-state network map according to some embodiments. Specifically, MV router or base node 500 (e.g., a “domain master,” such as PLC data concentrator or router 114) is in communication with a plurality of LV end nodes 501-503 (e.g., PLC devices 103, 112a-n, etc.). For convenience of explanation, the terms “uplink” and “downlink” are defined herein from the perspective of an end node. As such, a “downlink” communication indicates a communication flowing from an MV power line to an LV power line (i.e., from base node 500 to one of end nodes 501-503), whereas an “uplink” communication refers to a communication flowing from the LV power line to the MV power line (i.e., from one of end nodes 501-503 to base node 500).

As illustrated in this example, base node 500 may transmit signals to end node 501 using downlink subband 1, and it may receive signals from end node 501 through uplink subband 4. Base node 500 may also transmit signals to end node 502 using downlink subbands 2 and 3, and it may receive signals from end node 502 through uplink subband 2. Also, base node 500 may transmit signals to end node 503 using downlink subband 3, and it may receive signals from end node 503 through uplink subband 1. In some implementations, each downlink/uplink channel or subband may be approximately 50-100 kHz wide, although other values may also be used depending upon the type of device and/or network conditions.

Thus, using certain techniques described herein, power line communications may be achieved across different voltage domains (e.g., MV and LV) using one or more different frequency subbands in the downlink and uplink directions. Accordingly, each PLV device involved in the communications may select (or allow the other device to select) good or better communication channels based, for example, on signal-to-noise ratio (SNR) measurements, congestion indicators, etc., as described in more detail below.

FIG. 6 is a graph of a time slot definition according to some embodiments. Particularly, a media access control (MAC) frame is divided into S slots 601 and 602 (for S=2, in this example). Each slot 601 and 602 may start at zero crossing of AC mains, and their slot durations may be multiples of the zero crossing period. Generally speaking, longer slot duration may create less communication overhead, but more latency. In some embodiments, a domain master (e.g., data concentrator or router 114) may determine slot duration and frame duration, as well as which subbands may be used in each slots 601 and 602. (In other embodiments, however, one or more end points may select their operating downlink and/or uplink subbands.) The domain master may also allocate slots 601 and 602 to be used in MV to LV and/or LV to MV communications, which may be signaled in beacons transmitted within MV to LV slots.

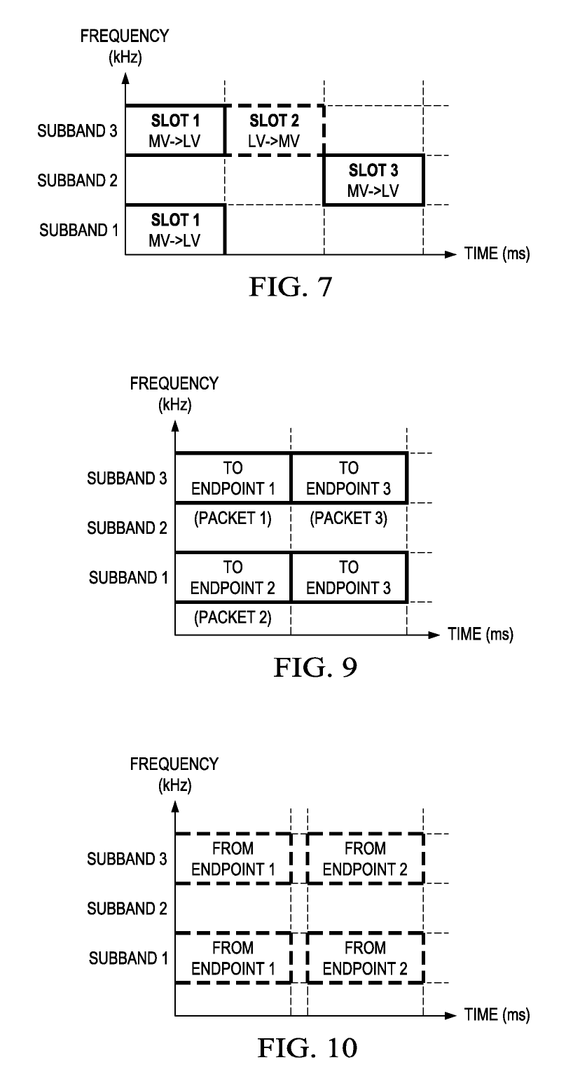

FIG. 7 is a graph providing an overview of slot usage according to some embodiments. As illustrated, the allocation of MV to LV and LV to MV slots may be signaled in beacons, which may be transmitted periodically on all sub-bands, for example. With respect to MV to LV slots (i.e., in the downlink direction), a domain master may transmit beacon/data packets on one or more subbands. End notes may be aware of which combination of downlink subbands they may receive these beacons/packets on, so they may monitor these subbands for transmissions. As to LV to MV slots (i.e., in the uplink direction), in some embodiments, an end node may transmit a packet at a time, and it may occupy more than one subband (depending on prior allocation). To avoid the “hidden node” problem, an end node may use a combination of reserved allocation and controlled contention techniques in its uplink transmissions.

As shown in FIG. 7, in some embodiments, a given subband (e.g., subband 3) may include downlink (MV->LV) slots and uplink (LV->MV) slots. Other subbands may, however, be dedicated to either downlink or uplink-only transmissions.

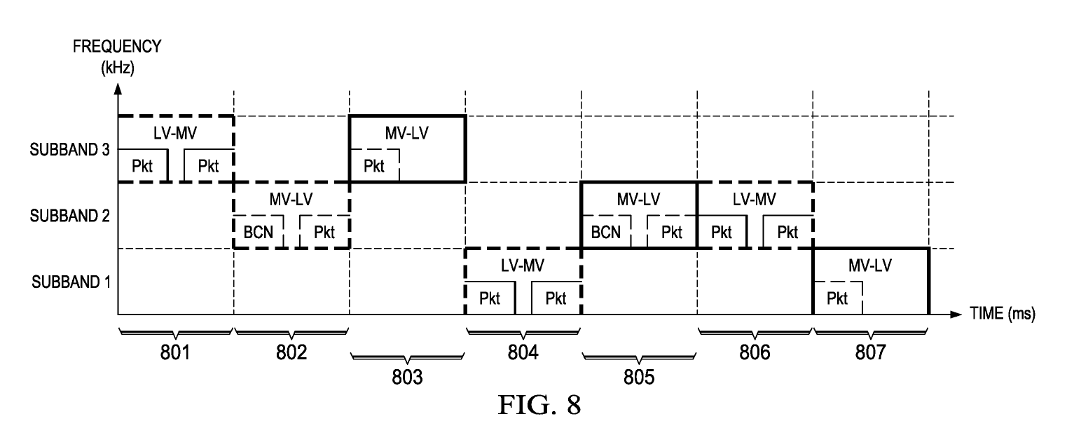

FIG. 8 is a diagram of a network discovery procedure according to some embodiments. As previously noted, a domain master may select a slot duration and allocation of slots, and transmit it in beacon packets, for example, on all MV to LV slots (i.e., in the downlink direction). In some implementations, on each subband, there may be at least one transmission (beacon/data) every N_{max-DL} ms. Data packets can be used by an end node to estimate the signal-to-noise ratio (SNR) in the particular downlink subband, whereas beacon packets may be used to obtain both SNR and time-frequency allocation.

At power up, an end node may search for a downlink signal on all subbands (i.e., subbands 1-3 in this example) and time slots 801-807. At slot 801, the end node begins monitoring subband 1. At slot 803, the end node receives a downlink packet, calculates an SNR value for subband 1, and switches monitoring to subband 2. At slot 805, the end node receives a beacon from the domain master, calculates the SNR ratio in subband 2, and learns the slot allocation from the received beacon information. At slot 807, the end node receives a packet in subband 3 and calculates the SNR value for that subband. (At slots 802, 804, and 806, the end node is either not monitoring the subband where packet(s) are being transmitted and/or the packet(s) are being transmitted in the uplink direction.) In addition to calculating SNR, in some cases, the end node may also estimate the usage of a particular channel or subband by determining how many other end nodes are receiving messages on that channel. Additionally or alternatively, channel usage information may be contained in a beacon message. As such, an end node may estimate and or receive a congestion indicator for each subband.

As illustrated in FIG. 8, an end node may dwell on each subband for some multiple of N_{max-DL} slots. In some cases, the end node may receive two or more subbands at the same time, and process them in parallel. At least one of the slots will contain a beacon, so after a monitoring time equal to the number of subbands times the N_{max-DL}, the end point may have detected the slot duration and allocation. In addition, the end point may also have calculated the channel quality (e.g., SNR and/or a congestion indicator) on all subbands.

In some embodiments, after having determined the SNR and/or congestion indicator for each downlink subband or channel, the end node may transmit an “association request” message to the domain master. For example, the association request may be transmitted on all uplink subbands in its corresponding time slot (i.e., using those time-frequency slots which are not allotted to transmission by other end points in the network). The association request may include, for example, an end node identifier, a router (i.e., domain master) identifier, and an SNR report measured by the end node at various subbands. The association request may also include a congestion indicator for each subband.

The domain master may then receive the association request and may transmit an “association accept” message on one or more of the subbands where the end node measured high SNR, low congestion levels, or some combination thereof. In some implementations, rather than transmitting a SNR and/or a congestion report to the domain master so that the domain master may select a good downlink channel for the end node to use in subsequent communications, the end node may itself select a downlink channel and transmit and indication of its selection to the domain master. Moreover, upon receiving association requests in each uplink subband, the domain master may choose an uplink subband suitable for use by the end node based on those requests, and may communicate its uplink channel selection to the end node using the selected downlink channel.

Once the domain master and/or the end node have initially selected the uplink and downlink channels, subsequent communications may take place using those selections. At the expiration of an update period (e.g., a few minutes) and/or upon detection of modified network conditions (e.g., new node entering network, changing noise levels in particular subbands, etc.), at least some of procedures described above may be repeated in order to update communication subbands for one or more end nodes.

FIG. 9 is a diagram of an example of steady-state MV to LV slot usage according to some embodiments. From the router's perspective (MV side), it may transmit one or more packets in each MV to LV slot, and those packets may contain beacon/data. For example, different packets may be intended for different group(s) of users. In some cases, one packet may span one or more subbands. In the illustrated example, packet 1 and packet 2 are transmitted on one subband each to different endpoints, but packet 3 is transmitted on two subbands to the same endpoint. The router may boost transmit signal so that MV router to LV endpoints may have wider subbands. Also, all of the subbands being used may have joint header/preamble (although in other embodiments each subband being used may have separate header/preamble).

From the end node's perspective (LV side), each end node or receiver knows the set of subband(s) to be monitored in a slot. Packets may be transmitted anywhere within the slot to the end points but in these pre-known subbands, which may be achieved, for example, by beacon signaling (common to all end points in the domain) or by individual signaling to endpoints (individual signaling, when available, may override beacon signaling). Also, each subband may have separate header/preamble.

FIG. 10 is a diagram of an example of steady state LV to MV slot usage according to some embodiments. From the router's perspective (MV side), it may operate in at least two different modes. In a basic mode, the router may be configured to only receive one packet at a time, but that packet may span more than one subband. In an enhanced mode, the router may receive multiple packets (i.e., “users”) at a time. Meanwhile, from the end node's perspective (LV side), if an endpoint has been granted access in a given slot, it may use the time allocated. For low-traffic networks, it may use contention (e.g., without time allocation).

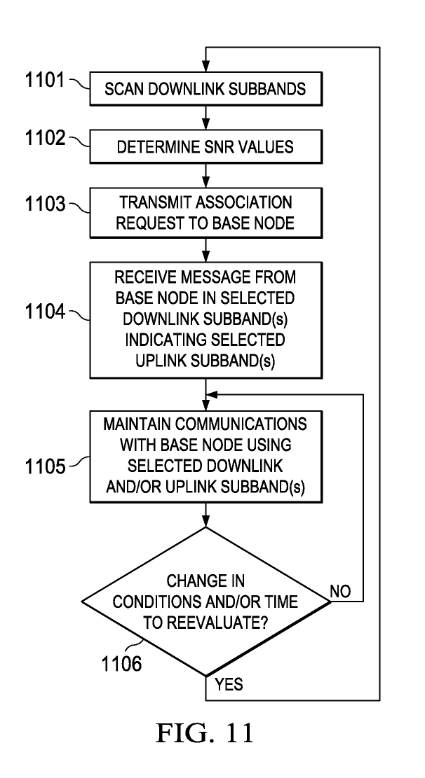

Turning now to FIG. 11, a flowchart of a method for PLC communications across different voltage domains using multiple frequency subbands from the perspective of an end node. In some embodiments, the method shown in FIG. 11 may be performed, at least in part, by PLC devices 113, PLC gateways 112a-n, or the like (i.e., an end device or node). At block 1101, the method may include scanning a plurality of downlink subbands usable by a base node (e.g., MV router 500, PLC data concentrator 114, etc.) to communicate with one or more other end devices from a medium voltage (MV) power line to a low voltage (LV) power line. In some implementations, scanning the plurality of downlink subbands may include scanning each of the plurality of downlink subbands over multiple time slots. Additionally or alternatively, scanning the plurality of downlink subbands may include scanning two or more of the plurality of downlink subbands in parallel.

At block 1102, method may include determining a signal-to-noise ratio (SNR) value for each of the plurality of downlink subbands. In some cases, determining the SNR for a given one of the plurality of downlink subbands may include receiving a beacon packet from the base node, the beacon packet having been transmitted using the given one of the plurality of downlink subbands.

At block 1103, the method may include transmitting an association request to the base node. The association request may include the SNR value for each of the plurality of downlink subbands, the association request configured to allow the base node to choose the one or more selected ones of the plurality of downlink subbands. Additionally or alternatively, the association request may include an indication of the one or more selected ones of the plurality of downlink subbands, and the one or more selected ones of the plurality of downlink subbands may have the smallest SNR values compared to other downlink subbands. In some cases, block 1103 may include transmitting the association request to the base node over two or more of a plurality of uplink subbands. The association request may be configured to allow the base node to choose one or more selected ones of the plurality of uplink subbands, and the received message may indicate the one or more selected ones of the plurality of uplink subbands.

At block 1104, the method may include, in response to the association request, receiving an association accept message from the base node addressed to the PLC device, the association accept message having been transmitted from the base node to the PLC device using one or more selected ones of the plurality of downlink subbands. Then, at block 1105, the method may include maintaining subsequent communications with the base node using the one or more selected ones of the plurality of downlink subbands and the one or more selected ones of the plurality of uplink subbands.

At block 1106, the method may determine whether there is a change in channel conditions (e.g., SNR in a particular channel, new device entering network, etc.). If so, the method may return to block 1101; otherwise control may return to block 1105.

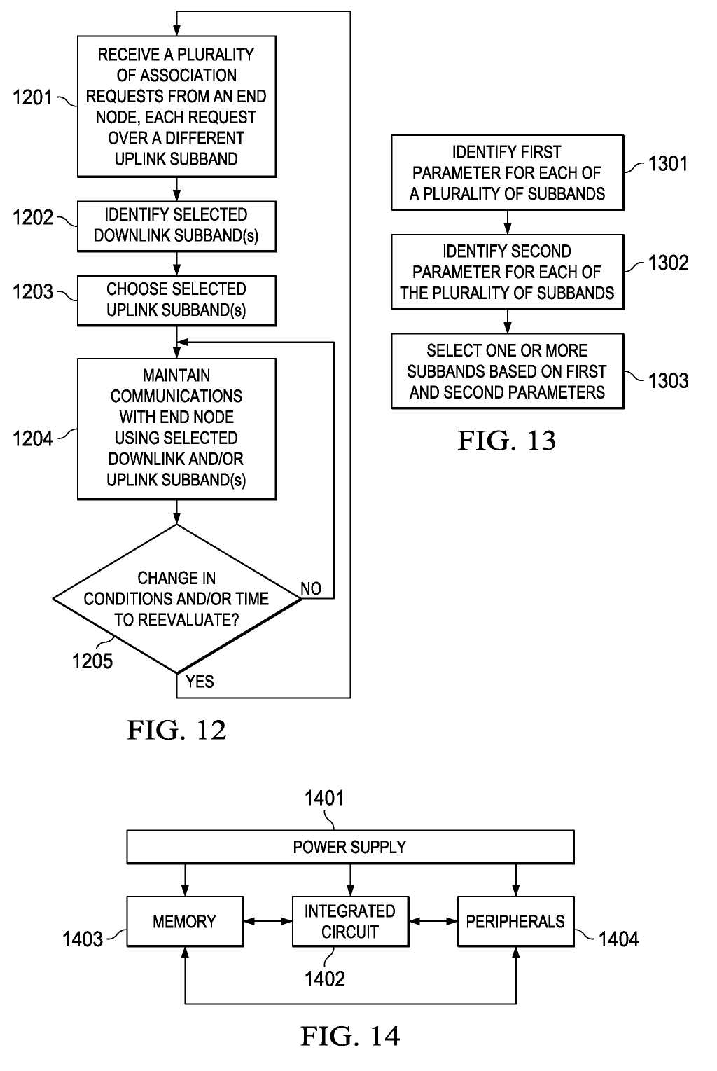

FIG. 12 is a flowchart of a method for PLC communications across different voltage domains using multiple frequency subbands from the perspective of a base device. In some embodiments, the method shown in FIG. 12 may be performed, at least in part, by MV router 500, PLC data concentrator 114, or the like (i.e., a domain master or base node). At block 1201, the method may include receiving a plurality of association requests from an end node, each of the plurality of association requests having been transmitted via one of a plurality of uplink subbands from a low voltage (LV) power line to a medium voltage (MV) power line. At block 1202, the method may include identifying, based at least in part upon the plurality of association requests, one or more selected ones of a plurality of downlink subbands. For example, each of the plurality of association requests may include a signal-to-noise ratio (SNR) value for each of the plurality of downlink subbands such that, to identify the one or more selected ones of the plurality of downlink subbands, the method may select one or more downlink subbands with smallest SNR values among other downlink subbands.

At block 1203, the method may include choosing, based at least in part upon the plurality of association requests, one or more selected ones of the plurality of uplink subbands. For instance, the method may include determining a signal-to-noise ratio (SNR) value for each of the plurality of uplink subbands based, at least in part, upon the plurality of association requests and selecting the one or more uplink subbands with smallest SNR values among other uplink subbands.

At block 1204, the method may include communicating with the end node using the one or more selected ones of the plurality of downlink subbands and the one or more selected ones of the plurality of uplink subbands. At block 1205, the method may determine whether there is a change in channel conditions (e.g., SNR in a particular channel, new device entering network, etc.). If so, the method may return to block 1201; otherwise control may return to block 1205.

FIG. 13 is a flowchart of another method for PLC communications across different voltage domains using multiple frequency subbands. In some embodiments, the method shown in FIG. 12 may be performed, for example, by PLC devices 113, PLC gateways 112a-n, or the like (i.e., an end device or node) and/or by MV router 500, PLC data concentrator 114, or the like (i.e., a domain master or base node). At block 1301, the method may include identifying a first parameter (e.g., an SNR value) for each of a plurality of subbands (e.g., downlink or uplink subbands). At block 1302, the method may include identifying a second parameter (e.g., a congestion indicator) corresponding to each of the plurality of subbands. Then, at block 1303, the method may include selecting the one or more of the plurality of subbands based, at least in part, upon the first and second parameters.

For example, in some cases, a first parameter (e.g., an SNR value) may indicate that a first channel is best suited for, for example, downlink communications. However, the second parameter may indicate that the first channel is already carrying particularly high amounts of traffic. In this scenario, an optimal combination of the two parameters may be determined from a trade-off evaluation. For instance, a second channel (with perhaps a “second best” SNR value) may have traffic congestion sufficiently lower than the traffic congestion of the first channel to justify the second channel's selection for use in subsequent communications.

FIG. 14 is a block diagram of an integrated circuit according to some embodiments. In some cases, one or more of the devices and/or apparatuses shown in FIGS. 1-4 may be implemented as shown in FIG. 14. In some embodiments, integrated circuit 1402 may be a digital signal processor (DSP), an application specific integrated circuit (ASIC), a system-on-chip (SoC) circuit, a field-programmable gate array (FPGA), a microprocessor, a microcontroller, or the like. Integrated circuit 1402 is coupled to one or more peripherals 1404 and external memory 1403. In some cases, external memory 1403 may be used to store and/or maintain databases 304 and/or 404 shown in FIGS. 3 and 4. Further, integrated circuit 1402 may include a driver for communicating signals to external memory 1403 and another driver for communicating signals to peripherals 1404. Power supply 1401 is also provided which supplies the supply voltages to integrated circuit 1402 as well as one or more supply voltages to memory 1403 and/or peripherals 1404. In some embodiments, more than one instance of integrated circuit 1402 may be included (and more than one external memory 1403 may be included as well).

Peripherals 1404 may include any desired circuitry, depending on the type of PLC system. For example, in an embodiment, peripherals 1404 may implement local communication interface 303 and include devices for various types of wireless communication, such as WI-FI, ZIGBEE, BLUETOOTH, cellular, global positioning system, etc. Peripherals 1404 may also include additional storage, including RAM storage, solid-state storage, or disk storage. In some cases, peripherals 1404 may include user interface devices such as a display screen, including touch display screens or multi-touch display screens, keyboard or other input devices, microphones, speakers, etc.

External memory 1403 may include any type of memory. For example, external memory 1403 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, DRAM, etc. External memory 1403 may include one or more memory modules to which the memory devices are mounted, such as single inline memory modules (SIMMs), dual inline memory modules (DIMMs), etc.

It will be understood that various operations illustrated in FIG. 6 may be executed simultaneously and/or sequentially. It will be further understood that each operation may be performed in any order and may be performed once or repetitiously. In various embodiments, the modules shown in FIGS. 2-4 may represent sets of software routines, logic functions, and/or data structures that are configured to perform specified operations. Although these modules are shown as distinct logical blocks, in other embodiments at least some of the operations performed by these modules may be combined in to fewer blocks. Conversely, any given one of the modules shown in FIGS. 2-4 may be implemented such that its operations are divided among two or more logical blocks. Moreover, although shown with a particular configuration, in other embodiments these various modules may be rearranged in other suitable ways.

Many of the operations described herein may be implemented in hardware, software, and/or firmware, and/or any combination thereof. When implemented in software, code segments perform the necessary tasks or operations. The program or code segments may be stored in a processor-readable, computer-readable, or machine-readable medium. The processor-readable, computer-readable, or machine-readable medium may include any device or medium that can store or transfer information. Examples of such a processor-readable medium include an electronic circuit, a semiconductor memory device, a flash memory, a ROM, an erasable ROM (EROM), a floppy diskette, a compact disk, an optical disk, a hard disk, a fiber optic medium, etc.

Software code segments may be stored in any volatile or non-volatile storage device, such as a hard drive, flash memory, solid state memory, optical disk, CD, DVD, computer program product, or other memory device, that provides tangible computer-readable or machine-readable storage for a processor or a middleware container service. In other embodiments, the memory may be a virtualization of several physical storage devices, wherein the physical storage devices are of the same or different kinds. The code segments may be downloaded or transferred from storage to a processor or container via an internal bus, another computer network, such as the Internet or an intranet, or via other wired or wireless networks.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

1. A method comprising:
performing, by a power line communication (PLC) device,
scanning a plurality of downlink subbands usable by a base node to communicate with one or more PLC devices from a medium voltage (MV) power line to a low voltage (LV) power line;
transmitting an association request to the base node; and
in response to the request, receiving a message from the base node addressed to the PLC device, the message having been transmitted from the base node to the PLC device using one or more selected ones of the plurality of downlink subbands.

2. The method of claim 1, wherein the PLC device includes a PLC modem.

3. The method of claim 2, wherein scanning the plurality of downlink subbands includes scanning each of the plurality of downlink subbands over multiple time slots.

4. The method of claim 2, wherein scanning the plurality of downlink subbands includes scanning two or more of the plurality of downlink subbands in parallel.

5. The method of claim 2, further comprising:
performing, by the PLC device,
determining a signal-to-noise ratio (SNR) value for each of the plurality of downlink subbands.

6. The method of claim 5, wherein determining the SNR for a given one of the plurality of downlink subbands includes receiving a beacon packet from the base node, the beacon packet having been transmitted using the given one of the plurality of downlink subbands.

7. The method of claim 5, wherein the association request includes the SNR value for each of the plurality of downlink subbands, the association request configured to allow the base node to choose the one or more selected ones of the plurality of downlink subbands.

8. The method of claim 5, wherein the association request includes an indication of the one or more selected ones of the plurality of downlink subbands, and wherein the one or more selected ones of the plurality of downlink subbands have the smallest SNR values compared to other downlink subbands.

9. The method of claim 2, wherein transmitting the association request further comprises transmitting the association request to the base node over two or more of a plurality of uplink subbands, the association request configured to allow the base node to choose one or more selected ones of the plurality of uplink subbands, and the received message indicating the one or more selected ones of the plurality of uplink subbands.

10. The method of claim 9, further comprising:
performing, by the PLC device,
maintaining subsequent communications with the base node using the one or more selected ones of the plurality of downlink subbands and the one or more selected ones of the plurality of uplink subbands.

11. The method of claim 10, further comprising:
performing, by the PLC device,
re-scanning the plurality of downlink subbands;
determining an updated signal-to-noise ratio (SNR) value for each of the plurality of downlink subbands; and
transmitting a message to the base node, the message including at least one of:
an indication of another selected one of the plurality of downlink subbands to be used in a subsequent communication; or
the updated SNR values for each of the plurality of downlink subbands, the message configured to allow the base node to choose another selected one of the plurality of downlink subbands to be used in a subsequent communication.

12. A power line communication (PLC) device comprising:
a processor; and
a memory coupled to the processor, the memory configured to store program instructions executable by the processor to cause the PLC device to:
receive a plurality of association requests from an end node, each of the plurality of association requests having been transmitted via one of a plurality of uplink subbands from a low voltage (LV) power line to a medium voltage (MV) power line;
identify, based at least in part upon the plurality of association requests, one or more selected ones of a plurality of downlink subbands;
choose, based at least in part upon the plurality of association requests, one or more selected ones of the plurality of uplink subbands; and
communicate with the end node using the one or more selected ones of the plurality of downlink subbands and the one or more selected ones of the plurality of uplink subbands.

13. The PLC device of claim 12, wherein the processor includes a digital signal processor (DSP), an application specific integrated circuit (ASIC), a system-on-chip (SoC) circuit, a field-programmable gate array (FPGA), a microprocessor, or a microcontroller.

14. The PLC device of claim 12, wherein each of the plurality of association requests includes a signal-to-noise ratio (SNR) value for each of the plurality of downlink subbands, and wherein to identify the one or more selected ones of the plurality of downlink subbands, the program instructions are further executable by the processor to cause the PLC device to:
select one or more downlink subbands with smallest SNR values among other downlink subbands.

15. The PLC device of claim 12, wherein to choose the one or more selected ones of the plurality of uplink subbands, the program instructions are further executable by the processor to cause the PLC device to:
determine a signal-to-noise ratio (SNR) value for each of the plurality of uplink subbands based, at least in part, upon the plurality of association requests; and
select the one or more uplink subbands with smallest SNR values among other uplink subbands.

16. A tangible electronic storage medium having program instructions stored thereon that, upon execution by a processor within a power line communication (PLC) device, cause the PLC device to:
identify a signal-to-noise ratio (SNR) value for each of a plurality of downlink subbands available for communications from a medium voltage (MV) power line to a low voltage (LV) power line;
select one or more of the plurality of downlink subbands to be used in subsequent communications from the MV power line to the LV power line based, at least, in part, upon the SNR values.

17. The tangible electronic storage medium of claim 16, wherein the PLC device is a PLC router.

18. The tangible electronic storage medium of claim 16, wherein the program instructions, upon execution by the processor, further cause the PLC device to:
identify a congestion indicator corresponding to each of the plurality of downlink subbands; and
select the one or more of the plurality of downlink subbands based, at least in part, upon the SNR values and the congestion indicators.

19. The tangible electronic storage medium of claim 16, wherein the program instructions, upon execution by the processor, further cause the PLC device to:
identify an SNR value for each of a plurality of uplink subbands available for communications from the LV power line to the MV power line;
select one or more of the plurality of uplink subbands to be used in subsequent communications from the LV power line to the MV power line based, at least, in part, upon the SNR values.

20. The tangible electronic storage medium of claim 16, wherein the program instructions, upon execution by the processor, further cause the PLC device to:
identify a congestion indicator corresponding to each of the plurality of uplink subbands; and
select the one or more of the plurality of uplink subbands based, at least in part, upon the SNR values and the congestion indicators.
